(19) United States
(12) Patent Application Publication
(10) Pub. No.: US 2021/0354868 A1
(43) Pub. Date: Nov. 18, 2021

(54) System and Method of Monitoring Product Packaging

(71) Applicant: Wuhan China Star Optoelectronics Technology Co., LTD., Wuhan, Hubei (CN)

(72) Inventor: Pengfei YU, Wuhan, Hubei (CN)

(73) Assignee: Wuhan China Star Optoelectronics Technology Co., Ltd., Wuhan, Hubei (CN)

(21) Appl. No.: 16/485,433

(22) PCT Filed: Apr. 28, 2019
(86) PCT No.: PCT/CN2019/084711

§ 371 Date: Aug. 12, 2019

(30) Foreign Application Priority Data
Nov. 29, 2018 (CN) 201811444555.X

(51) Int. Cl. B65B 57/10; G07C 3/14; G01G 19/414; B65B 57/18

(52) U.S. Cl. CPC B65B 57/10; B65B 57/18; G01G 19/414; G07C 3/14

(57) ABSTRACT

The present application provides a system and method of monitoring a product packaging. By obtaining an actual weight value and theoretical weight parameters of a target packaging bag and analyzing whether the actual weight value matches the theoretical weight parameters, the target packaging bag is regarded as a packaging failure when the actual weight value fails to match the theoretical weight parameters. In the present application, after product packaging, weighing the packaging bag to obtain the actual weight value and matching the actual weight value for the theoretical weight parameters to realize the monitoring of whether the packaging bag is regarded as the packaging failure.

### BACKGROUND OF INVENTION

### 1. Field of Invention

The present invention relates to a manufacturing field, and particularly, to a system and a method of monitoring product packaging.

### 2. Related Art

A current product shipment process is as follows: product line quality control→product shipment quality control→count number of products before inner packaging→product inner packaging→product outer packaging→product in stock→logistics shipment. Since number of products counted before inner packaging is carried out at a separate station from inner packaging of products, the number of products before and after the inner packaging of the products does not match due to manual mistakes of incorrect counting.

In other words, a technique problem that number of products before and after inner packaging of products is inconsistent exists in current product shipment technique.

### SUMMARY OF INVENTION

The present application provides a system and method of monitoring product packaging to a technique problem that number of products before and after inner packaging of products is inconsistent exists in current product shipment technique.

To overcome the above-mentioned problem, the present application provides a technical solution as follows:

An embodiment of the present application provides a system of monitoring a product packaging, comprising a weighing module configured to weigh a target packaging bag to obtain an actual weight value of the target packaging bag, wherein the target packaging bag is defined to contain products inside the target packaging bag; a calculation module configured to obtain theoretical weight parameters of the target packaging bag according to packaging parameters of the target packaging bag; and an analysis module configured to analyze whether the actual weight value matches the theoretical weight parameters, wherein the target packaging bag is defined as a packaging failure when the actual weight value fails to match the theoretical weight parameters.

In the system of monitoring the product packaging, the theoretical weight parameters comprise a theoretical weight value and a tolerance value, and the analysis module is configured to obtain an actual difference value between the actual weight value and the theoretical weight value and to determine whether the actual difference value is less than the tolerance value, wherein when the actual difference value is not less than the tolerance value, the actual weight value fails to match the theoretical weight parameters.

In the system of monitoring the product packaging, the theoretical weight parameters comprise a theoretical weight value and an error rate, and the analysis module is configured to obtain an actual difference value between the actual weight value and the theoretical weight value, to calculate a ratio of the actual difference value to the theoretical weight value, and to determine whether the ratio is less than the error rate, wherein when the actual difference value is not less than the error rate, the actual weight value fails to match the theoretical weight parameters.

In the system of monitoring the product packaging, the calculation module is configured to obtain a theoretical weight value of the theoretical weight parameters by calculation according to a packaging object list and a packaging object weight of the packaging parameters.

In the system of monitoring the product packaging, the calculation module is configured to obtain the theoretical weight value of the theoretical weight parameters by calculation according to number of products, number of packaging bags, number of trays, and number of desiccant bags on the packaging object list, and individual product weight, individual packaging bag weight, individual tray weight, and individual desiccant bag weight included in the packaging object weight.

In the system of monitoring the product packaging, the system comprises an alarm module configured to provide a reminder of the packaging failure when the target packaging bag is defined as the packaging failure according to an analysis result of the analysis module.

In the system of monitoring the product packaging, the alarm module is configured to provide a reminder of the packaging failure by a reminder sound.

In the system of monitoring the product packaging, the alarm module is configured to provide a reminder of the packaging failure by using a flashing light.

In the system of monitoring the product packaging, the system further comprises a culling module configured to remove the target packaging bag defined as the packaging failure from an assembly line.

In the system of monitoring the product packaging, the system further comprises a correction module configured to correct the theoretical weight parameters according to an analysis result of the analysis module.

An embodiment of the present application further provides a method of monitoring a product packaging, comprising obtaining, by weighing a target packaging bag, an actual weight value of the target packaging bag, wherein the target packaging bag is defined to contain products inside the target packaging bag; obtaining theoretical weight parameters of the target packaging bag according to packaging parameters of the target packaging bag; and analyzing whether the actual weight value matches the theoretical weight parameters, wherein the target packaging bag is defined as a packaging failure when the actual weight value fails to match the theoretical weight parameters.

In the method of monitoring the product packaging, the theoretical weight parameters comprise a theoretical weight value and a tolerance value, and the analyzing whether the actual weight value matches the theoretical weight parameters comprises: obtaining an actual difference value between the actual weight value and the theoretical weight value and to determine whether the actual difference value is less than the tolerance value, wherein when the actual difference value is not less than the tolerance value, the actual weight value fails to match the theoretical weight parameters.

In the method of monitoring the product packaging, the theoretical weight parameters comprise a theoretical weight value and an error rate, and the analyzing whether the actual weight value matches the theoretical weight parameters comprises: obtaining an actual difference value between the actual weight value and the theoretical weight value, calculating a ratio of the actual difference value to the theoretical weight value, and determining whether the ratio is less than the error rate, wherein when the actual difference value is not less than the error rate, the actual weight value fails to match the theoretical weight parameters.

In the method of monitoring the product packaging, the obtaining theoretical weight parameters of the target packaging bag according to packaging parameters of the target packaging bag comprises: obtaining, by calculation, a theoretical weight value of the theoretical weight parameters according to a packaging object list and a packaging object weight of the packaging parameters.

In the method of monitoring the product packaging, the obtaining, by calculation, a theoretical weight value of the theoretical weight parameters according to a packaging object list and a packaging object weight of the packaging parameters comprises: obtaining, by calculation, the theoretical weight value of the theoretical weight parameters according to number of products, number of packaging bags, number of trays, and number of desiccant bags on the packaging object list, and individual product weight, individual packaging bag weight, individual tray weight, and individual desiccant bag weight included in the packaging object weight.

In the method of monitoring the product packaging, the method further comprises providing a reminder of the packaging failure when the target packaging bag is defined as the packaging failure according to an analysis result.

In the method of monitoring the product packaging, the providing a reminder of the packaging failure comprises: providing a reminder of the packaging failure by a reminder sound.

In the method of monitoring the product packaging, the providing a reminder of the packaging failure comprises: providing a reminder of the packaging failure by using a flashing light.

In the method of monitoring the product packaging, the method further comprises removing the target packaging bag defined as the packaging failure from an assembly line to prevent the target packaging bag defined as the packaging failure from slipping into a subsequent outer packaging.

In the method of monitoring the product packaging, the method further comprises correcting the theoretical weight parameters according to the analysis result.

The present application has advantageous effects as follows: the present application provides a novel system and method of monitoring a product packaging that is performed by obtaining the actual weight value of the target packaging bag by weighing the target packaging bag, then obtaining the theoretical weight parameters of the target packaging bag according to the packaging parameters of the target packaging bag, and finally analyzing whether the actual weight value matches the theoretical weight parameters. The target packaging bag is defined as a packaging failure when the actual weight value fails to match the theoretical weight parameters. In this manner, by monitoring after product packaging, weighing the packaging bag to obtain the actual weight value, and matching the actual weight value for the theoretical weight parameters, the monitoring of whether the packaging bag is regarded as the packaging failure is realized, thereby ensuring the same number of products before and after the product packaging, and overcoming the technical problem that the number of products before and after inner packaging is inconsistent in conventional product shipment technique.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic view of a system of monitoring product packaging of an embodiment of the present application.

FIG. 2 is a flowchart of a system of monitoring product packaging of an embodiment of the present application.

FIG. 3 is a schematic view illustrating a product packaging of an embodiment of the present application.

### DESCRIPTION OF PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, elements with similar structures are labeled with like reference numerals.

Embodiments of the present application can overcome a technical problem that number of products before and after inner packaging is inconsistent in current product shipment technique.

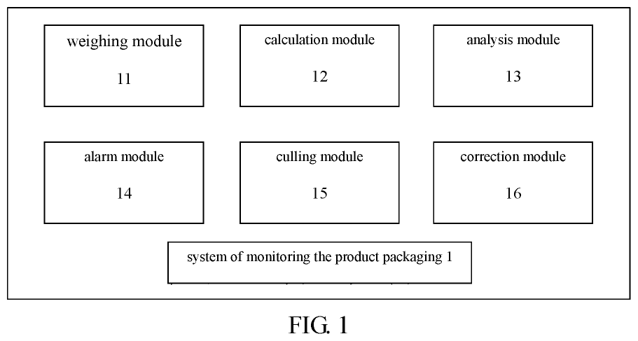

In one embodiment, as shown in FIG. 1, the present application provides a system 1 of monitoring a product packaging including: a weighing module 11 configured to weigh a target packaging bag to obtain an actual weight value of the target packaging bag, wherein the target packaging bag is defined to contain products packaged inside the target packaging bag.

A calculation module12 is configured to obtain theoretical weight parameters of the target packaging bag according to packaging parameters of the target packaging bag.

An analysis module 13 is configured to analyze whether the actual weight value matches the theoretical weight parameters, wherein the target packaging bag is defined as a packaging failure when the actual weight value fails to match the theoretical weight parameters.

In one embodiment, the theoretical weight parameters include a theoretical weight value and a tolerance value. The analysis module 13 is configured to obtain an actual difference value between the actual weight value and the theoretical weight value and to determine whether the actual difference value is less than the tolerance value. When the actual difference value is not less than the tolerance value, the actual weight value fails to match the theoretical weight parameters. For example, the theoretical weight value is 5000 grams and the tolerance value is plus or minus 50 grams. When the actual weight value of a packaging bag is 4990 grams, the actual difference value is 10 grams and is less than the tolerance value, so that a condition of the packaging bag is not regarded as the packaging failure. When the actual weight value of the packaging bag is 4900 grams, the actual difference value is 100 grams greater than the tolerance value, so that the packaging bag is defined as the packaging failure.

In one embodiment, the theoretical weight parameters include a theoretical weight value and an error rate. The analysis module 13 is configured to obtain an actual difference value between the actual weight value and the theoretical weight value, to calculate a ratio of the actual difference value to the theoretical weight value, and to determine whether the ratio is less than the error rate. When the actual difference value is not less than the error rate, the actual weight value fails to match the theoretical weight parameters. For example, the theoretical weight value is 5000 grams, and the error rate is plus or minus 1%. When the actual weight value of a packaging bag is 4990 grams, the actual difference value is 10 grams. That is, a ratio of the actual difference value to the theoretical weight value is 0.2% less than the error rate, so that the packaging bag is not regarded as the packaging failure. When the actual weight value of a packaging bag is 4900 grams, the actual difference value is 100 grams. That is, a ratio of the actual difference value to the theoretical weight value is 2% greater than the error rate, so that the packaging bag is defined as the packaging failure.

In one embodiment, the calculation module 12 is configured to obtain a theoretical weight value of the theoretical weight parameters by calculation according to a packaging object list and a packaging object weight of the packaging parameters.

In one embodiment, the calculation module 12 is configured to obtain the theoretical weight value of the theoretical weight parameters by calculation according to number of products, number of packaging bags, number of trays, and number of desiccant bags on the packaging object list, and individual product weight, individual packaging bag weight, individual tray weight, and individual desiccant bag weight included in the packaging object weight.

In one embodiment, as shown in FIG. 1, the system 1 of monitoring the product packaging further includes an alarm module 14 configured to provide a reminder of the packaging failure when the target packaging bag is defined as the packaging failure according to an analysis result of the analysis module 13.

In one embodiment, the alarm module 14 is configured to provide a reminder of the packaging failure by a reminder sound, such as an audio voice of “product packaging failure”, etc.

In one embodiment, the alarm module 14 is configured to provide a reminder of the packaging failure by using a flashing light.

In one embodiment, as shown in FIG. 1, the system 1 of monitoring the product packaging further includes culling module 15 configured to remove a target packaging bag defined as the packaging failure from an assembly line, thereby to prevent the target packaging bag defined as the packaging failure from slipping into a subsequent outer packaging process.

In one embodiment, as shown in FIG. 1, the system 1 of monitoring the product packaging further includes a correction module 16 configured to correct the theoretical weight parameters according to an analysis result of the analysis module 13. For example, when the analysis result of the analysis module 13 indicates that 20 successive packaging bags are defined as the packaging failure and the actual weight value of each of the successive target packaging bags is substantially the same, the theoretical weight parameters need to be corrected to prevent error data input of the theoretical weight parameters from giving rise to error detection.

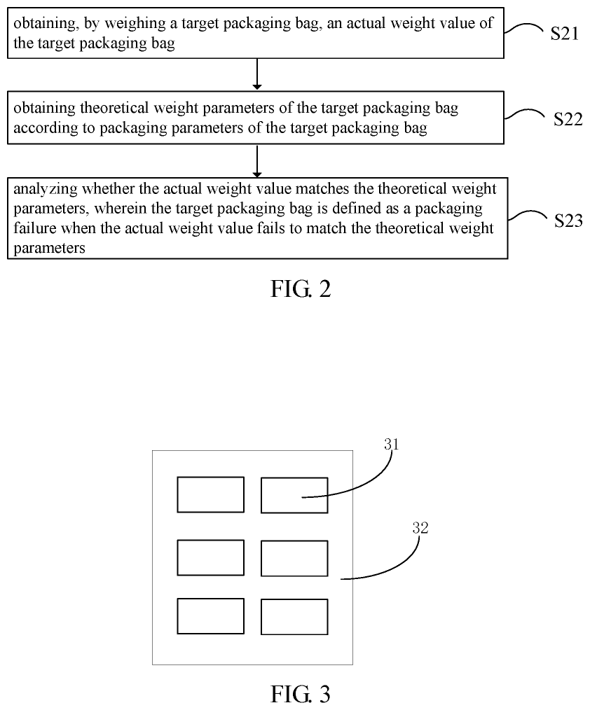

In one embodiment, as shown in FIG. 2, the present application provides a method of monitoring a product packaging including steps as follows:

S21: obtaining an actual weight value of the target packaging bag by weighing a target packaging bag, wherein the target packaging bag is defined to contain products inside the target packaging bag.

S22: obtaining theoretical weight parameters of the target packaging bag according to packaging parameters of the target packaging bag.

S23: analyzing whether the actual weight value matches the theoretical weight parameters, wherein the target packaging bag is defined as a packaging failure when the actual weight value fails to match the theoretical weight parameters.

In one embodiment, the theoretical weight parameters include a theoretical weight value and a tolerance value, and step S23 includes: obtaining an actual difference value between the actual weight value and the theoretical weight value and to determine whether the actual difference value is less than the tolerance value. When the actual difference value is not less than the tolerance value, the actual weight value fails to match the theoretical weight parameters. For example, the theoretical weight value is 5000 grams and the tolerance value is plus or minus 50 grams. When the actual weight value of a packaging bag is 4990 grams, the actual difference value is 10 grams less than the tolerance value, so that a condition of the packaging bag is not regarded as the packaging failure. When the actual weight value of the packaging bag is 4900 grams, the actual difference value is 100 grams greater than the tolerance value, so that the packaging bag is defined as the packaging failure.

In one embodiment, the theoretical weight parameters include a theoretical weight value and an error rate, and step S23 includes: obtaining an actual difference value between the actual weight value and the theoretical weight value, calculating a ratio of the actual difference value to the theoretical weight value, and determining whether the ratio is less than the error rate. When the actual difference value is not less than the error rate, the actual weight value fails to match the theoretical weight parameters. For example, the theoretical weight value is 5000 grams, and the error rate is plus or minus 1%. When the actual weight value of a packaging bag is 4990 grams, the actual difference value is 10 grams. That is, a ratio of the actual difference value to the theoretical weight value is 0.2% less than the error rate, so that the packaging bag is not regarded as the packaging failure. When the actual weight value of a packaging bag is 4900 grams, the actual difference value is 100 grams. That is, a ratio of the actual difference value to the theoretical weight value is 2% greater than the error rate, so that the packaging bag is defined as the packaging failure.

In one embodiment, step S22 includes: obtaining a theoretical weight value of the theoretical weight parameters by calculation according to a packaging object list and a packaging object weight of the packaging parameters.

In one embodiment, the step of obtaining a theoretical weight value of the theoretical weight parameters by calculation according to a packaging object list and a packaging object weight of the packaging parameters including: obtaining the theoretical weight value of the theoretical weight parameters by calculation according to number of products, number of packaging bags, number of trays, and number of desiccant bags on the packaging object list, and individual product weight, individual packaging bag weight, individual tray weight, and individual desiccant bag weight included in the packaging object weight.

In one embodiment, the method of monitoring the product packaging further includes: providing a reminder of the packaging failure when the target packaging bag is defined as the packaging failure according to an analysis result.

In one embodiment, the step of providing a reminder of the packaging failure includes: providing the reminder of the packaging failure by a reminder sound, such as an audio voice of “product packaging failure”, etc.

In one embodiment, the step of providing a reminder of the packaging failure includes: providing a reminder of the packaging failure by using a flashing light.

In one embodiment, the method of monitoring the product packaging further includes: removing the target packaging bag defined as the packaging failure from an assembly line to prevent the target packaging bag defined as the packaging failure from slipping into a subsequent outer packaging.

In one embodiment, the method of monitoring the product packaging further includes: correcting the theoretical weight parameters according to the analysis result. For example, when the analysis result of the analysis module 13 indicates that 20 successive packaging bags are defined as the packaging failure and the actual weight value of each of the successive target packaging bags is substantially the same, the theoretical weight parameters need to be corrected to prevent error data input of the theoretical weight parameters from giving rise to error detection.

The application is now further explained by taking shipment packaging of display panels as an example.

As shown in FIG. 3, display panels 31 are securely held on a tray 32 in an inner packaging process. Each tray 32 is allowed to securely hold six display panels 31, and the inner packaging process is carried out after 20 holding trays are fully prepared with the display panels.

Accordingly, a method of monitoring a product packaging in accordance with an embodiment is as follows:

A first step: confirming a packaging object list, wherein the packaging object list corresponding to inner packaging contains: one packaging bag, 20 trays, and two desiccant bags.

A second step: confirming a packaging object weight, wherein a tolerance value of a single object is within 5 grams, a total tolerance value after packaging is 50 within grams, and a single object weight value is between 70 to 150 grams depending on product size and shipping types.

A third step: calculating theoretical weight parameters, including: recording number of products to be packaged as a system input according to a previous station, and calculating the theoretical quality parameters according to the following formula: the theoretical weight value=a single product weight×number of products+a single packaging bag weight×number of packaging bags+a single tray weight×number of trays+a single desiccant bag weight×number of desiccant bags.

For example, the single product weight is 100 grams, the number of products is 120, the packaging weight is 50 grams, the number of bags is one, the single tray weight is 20 grams, the number of trays is 20, the single desiccant bag weight is 20 grams, and the number of desiccant bags is 2. That is, the theoretical weight value=100×120+50×1+20×20+20×2=12445 grams.

A fourth step: measuring an actual weight value of the packaging bag by a weighing equipment, wherein an actual weight value corresponding to a first packaging bag is 12440 grams, and the actual weight value corresponding to the second packaging bag is 12000 grams.

A fifth step: comparing an amount of (the theoretical weight value±the tolerance value) with the actual weight value. For example, when a system indicates that there is a packaging failure, the packaging bag is unpacked to count the number of products in the packaging bag. For example, for the first packaging bag, when no packaging failure is reported after comparison of (theoretical weight value±the tolerance value) and the actual weight value, no further action is required. For the second packaging bag, when the packaging failure is reported after comparison of (theoretical weight value±the tolerance value) and the actual weight value, the second packaging bag is unpacked to count the number of products inside.

According to the above-mentioned embodiments, the present application provides a novel system and method of monitoring a product packaging that is performed by obtaining the actual weight value of the target packaging bag by weighing the target packaging bag, then obtaining the theoretical weight parameters of the target packaging bag according to the packaging parameters of the target packaging bag, and finally analyzing whether the actual weight value matches the theoretical weight parameters. The target packaging bag is defined as a packaging failure when the actual weight value fails to match the theoretical weight parameters. In this manner, by monitoring after product packaging, weighing the packaging bag to obtain the actual weight value, and matching the actual weight value for the theoretical weight parameters, the monitoring of whether the packaging bag is regarded as the packaging failure is realized, thereby ensuring the same number of products before and after the product packaging, and overcoming the technical problem that the number of products before and after inner packaging is inconsistent in conventional product shipment technique.

Accordingly, although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents.

What is claimed is:

1. A system of monitoring a product packaging, comprising:
a weighing module configured to weigh a target packaging bag to obtain an actual weight value of the target packaging bag, wherein the target packaging bag is defined to contain products inside the target packaging bag;
a calculation module configured to obtain theoretical weight parameters of the target packaging bag according to packaging parameters of the target packaging bag; and
an analysis module configured to analyze whether the actual weight value matches the theoretical weight parameters, wherein the target packaging bag is defined as a packaging failure when the actual weight value fails to match the theoretical weight parameters.

2. The system of monitoring the product packaging of claim 1, wherein the theoretical weight parameters comprise a theoretical weight value and a tolerance value, and the analysis module is configured to obtain an actual difference value between the actual weight value and the theoretical weight value and to determine whether the actual difference value is less than the tolerance value, wherein when the actual difference value is not less than the tolerance value, the actual weight value fails to match the theoretical weight parameters.

3. The system of monitoring the product packaging of claim 1, wherein the theoretical weight parameters comprise a theoretical weight value and an error rate, and the analysis module is configured to obtain an actual difference value between the actual weight value and the theoretical weight value, to calculate a ratio of the actual difference value to the theoretical weight value, and to determine whether the ratio is less than the error rate, wherein when the actual difference value is not less than the error rate, the actual weight value fails to match the theoretical weight parameters.

4. The system of monitoring the product packaging of claim 1, wherein the calculation module is configured to obtain a theoretical weight value of the theoretical weight parameters by calculation according to a packaging object list and a packaging object weight of the packaging parameters.

5. The system of monitoring the product packaging of claim 4, wherein the calculation module is configured to obtain the theoretical weight value of the theoretical weight parameters by calculation according to number of products, number of packaging bags, number of trays, and number of desiccant bags on the packaging object list, and individual product weight, individual packaging bag weight, individual tray weight, and individual desiccant bag weight included in the packaging object weight.

6. The system of monitoring the product packaging of claim 1, further comprising an alarm module configured to provide a reminder of the packaging failure when the target packaging bag is defined as the packaging failure according to an analysis result of the analysis module.

7. The system of monitoring the product packaging of claim 1, wherein the alarm module is configured to provide a reminder of the packaging failure by a reminder sound.

8. The system of monitoring the product packaging of claim 1, wherein the alarm module is configured to provide a reminder of the packaging failure by using a flashing light.

9. The system of monitoring the product packaging of claim 1, further comprising a culling module configured to remove the target packaging bag defined as the packaging failure from an assembly line.

10. The system of monitoring the product packaging of claim 1, further comprising a correction module configured to correct the theoretical weight parameters according to an analysis result of the analysis module.

11. A method of monitoring a product packaging, comprising:
obtaining, by weighing a target packaging bag, an actual weight value of the target packaging bag, wherein the target packaging bag is defined to contain products inside the target packaging bag;
obtaining theoretical weight parameters of the target packaging bag according to packaging parameters of the target packaging bag; and
analyzing whether the actual weight value matches the theoretical weight parameters, wherein the target packaging bag is defined as a packaging failure when the actual weight value fails to match the theoretical weight parameters.

12. The method of monitoring the product packaging of claim 11, wherein the theoretical weight parameters comprise a theoretical weight value and a tolerance value, and the analyzing whether the actual weight value matches the theoretical weight parameters comprises:
obtaining an actual difference value between the actual weight value and the theoretical weight value and to determine whether the actual difference value is less than the tolerance value, wherein when the actual difference value is not less than the tolerance value, the actual weight value fails to match the theoretical weight parameters.

13. The method of monitoring the product packaging of claim 11, wherein the theoretical weight parameters comprise a theoretical weight value and an error rate, and the analyzing whether the actual weight value matches the theoretical weight parameters comprises:
obtaining an actual difference value between the actual weight value and the theoretical weight value, calculating a ratio of the actual difference value to the theoretical weight value, and determining whether the ratio is less than the error rate, wherein when the actual difference value is not less than the error rate, the actual weight value fails to match the theoretical weight parameters.

14. The method of monitoring the product packaging of claim 11, wherein the obtaining theoretical weight parameters of the target packaging bag according to packaging parameters of the target packaging bag comprises:
obtaining, by calculation, a theoretical weight value of the theoretical weight parameters according to a packaging object list and a packaging object weight of the packaging parameters.

15. The method of monitoring the product packaging of claim 14, wherein the obtaining, by calculation, a theoretical weight value of the theoretical weight parameters according to a packaging object list and a packaging object weight of the packaging parameters comprises:
obtaining, by calculation, the theoretical weight value of the theoretical weight parameters according to number of products, number of packaging bags, number of trays, and number of desiccant bags on the packaging object list, and individual product weight, individual packaging bag weight, individual tray weight, and individual desiccant bag weight included in the packaging object weight.

16. The method of monitoring the product packaging of claim 11, further comprising providing a reminder of the packaging failure when the target packaging bag is defined as the packaging failure according to an analysis result.

17. The method of monitoring the product packaging of claim 16, wherein the providing a reminder of the packaging failure comprises: providing a reminder of the packaging failure by a reminder sound.

18. The method of monitoring the product packaging of claim 16, wherein the providing a reminder of the packaging failure comprises: providing a reminder of the packaging failure by using a flashing light.

19. The method of monitoring the product packaging of claim 16, further comprising removing the target packaging bagdefined as the packaging failure from an assembly line to prevent the target packaging bagdefined as the packaging failure from slipping into a subsequent outer packaging.

20. The method of monitoring the product packaging of claim 16, further comprising correcting the theoretical weight parameters according to the analysis result.
